(19) United States
(12) Patent Application Publication
(10) Pub. No.: US 2006/0026647 A1
(43) Pub. Date: Feb. 2, 2006

(54) Methods and systems for recording programs

(75) Inventors: Peter J. Potrebic, Calistoga, CA (US); Joseph Alton Schrader, Woodinville, WA (US); Waiman Lam, Sammamish, WA (US); Thomas H. Taylor, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/929,349

(22) Filed: Aug. 30, 2004

Related U.S. Application Data
(63) Continuation of application No. 10/909,808, filed on Jul. 30, 2004.

(51) Int. Cl. H04N 5/445; G06F 13/00; G06F 3/00

(52) U.S. Cl. 725/53; 725/52; 725/39

(57) ABSTRACT

Methods and systems that enable users to find and view programs are described. In one embodiment, a user request associated with a program that does not occur in a current electronic program guide is received and a record request is created based on the user's request. A recording associated with the record request is then made. In another embodiment, a client device presents a user interface that allows a user to make a selection to view a program that is not included in a current electronic program guide associated with the client device. A unique marker associated with the program is then used to search for the program in a future electronic program guide. If the program is found in a future electronic program guide, the program is recorded.

### RELATED APPLICATION

This application is a continuation of and claims priority to U.S. patent application Ser. No. 10/909,808, entitled “Program Portals and Methods and Systems for Finding and Viewing Programs”, filed on Jul. 30, 2004, bearing attorney docket number ms1-2130us, the disclosure of which is incorporated by reference herein.

### TECHNICAL FIELD

This invention relates to television-associated methods and systems, and particularly to methods and systems that enable users to find and view programs and related information.

### BACKGROUND

With the convergence of home entertainment technologies, there are a growing number of devices that store many different forms of content, such as music, movies, pictures, TV, videos, games, and so forth. Devices like digital video recorders (DVRs), personal video recorders (PVRs), game consoles, and entertainment-configured computers (e.g., computers running the Windows® XP Media Center operating system from Microsoft Corporation) enable users to record, manage, and playback many different forms of content. Even less featured devices, such as set-top boxes, can be designed to record multiple types of content.

Each week there are hundreds and sometimes thousands of programs on television. Current technology for finding program types and specific programs to permit either viewing and/or recording is still not at a point that makes the user experience all that it could be.

Consider, for example, the several different ways today that a user might find a particular program of interest. The user might, for example, access an electronic program guide (EPG) and channel up or down in order to find a particular program of interest, or enter a specific channel in the guide to see what is currently playing on that channel. This process constitutes a slow “hunt and peck” type of approach that can be imprecise and time consuming. Alternately, the user might select different program types in an EPG menu, such as movies or sports, to see a flat text list of the programs within that particular type. In addition, some technologies permit a user to manually enter a text string, often using their remote control, on which to search. For example, if a user wishes to find the program “Match Game 76”, then the user might manually enter the letters “M”-“A”-“T”-“C”-“H” and so on, in order to generate a search of the EPG data for text string matches. Those who have manually entered textual search strings will agree that the process is quite cumbersome. In addition, the user may not enter or even know the correct title of the program in which they are interested. In this case, the user will most certainly miss programs of interest.

It would be helpful to have systems and methods that permit users to easily find, view and/or record programs that are of interest to them.

### SUMMARY

Methods and systems that enable users to find and view programs are described. In one embodiment, a user request associated with a program that does not occur in a current electronic program guide is received and a record request is created based on the user's request. A recording associated with the record request is then made. In another embodiment, a client device presents a user interface that allows a user to make a selection to view a program that is not included in a current electronic program guide associated with the client device. A unique marker associated with the program is then used to search for the program in a future electronic program guide. If the program is found in a future electronic program guide, the program is recorded.

### BRIEF DESCRIPTION OF THE DRAWINGS

FIG. 1 is a block diagram of an exemplary system in which the inventive embodiments can be practiced.

FIG. 2 is an illustration of an exemplary user interface in accordance with one embodiment.

FIG. 3 is an illustration of an exemplary user interface in accordance with one embodiment.

FIG. 4 is an illustration of an exemplary user interface in accordance with one embodiment.

FIG. 5 is an illustration of an exemplary user interface in accordance with one embodiment.

FIG. 6 is an illustration of an exemplary user interface in accordance with one embodiment.

FIG. 7 is an illustration of an exemplary user interface in accordance with one embodiment.

FIG. 8 is a flow diagram that describes a method in accordance with one embodiment.

FIG. 9 is an illustration of an exemplary user interface in accordance with one embodiment.

FIG. 10 is an illustration of an exemplary user interface in accordance with one embodiment.

FIG. 11 is an illustration of an exemplary user interface in accordance with one embodiment.

FIG. 12 is an illustration of an exemplary user interface in accordance with one embodiment.

FIG. 13 is an illustration of an exemplary user interface in accordance with one embodiment.

FIG. 14 is a flow diagram that describes a method in accordance with one embodiment.

FIG. 15 is an illustration of an exemplary user interface in accordance with one embodiment.

FIG. 16 is an illustration of an exemplary user interface in accordance with one embodiment.

FIG. 17 is a flow diagram that describes a method in accordance with one embodiment.

### DETAILED DESCRIPTION

Overview

The following disclosure describes techniques for finding, watching and recording programs. The following discussion is directed to audio and/or graphics entertainment and information systems, including television-based systems, such as broadcast TV networks, interactive TV networks, cable networks, and Web- enabled TV networks. While aspects of the described systems and methods can be implemented in any number of television-based entertainment and information systems, such as computers running the Windows® XP Media Center operating system from Microsoft Corporation, and within any number and types of client devices, the systems and methods are described in the context of the following exemplary system.

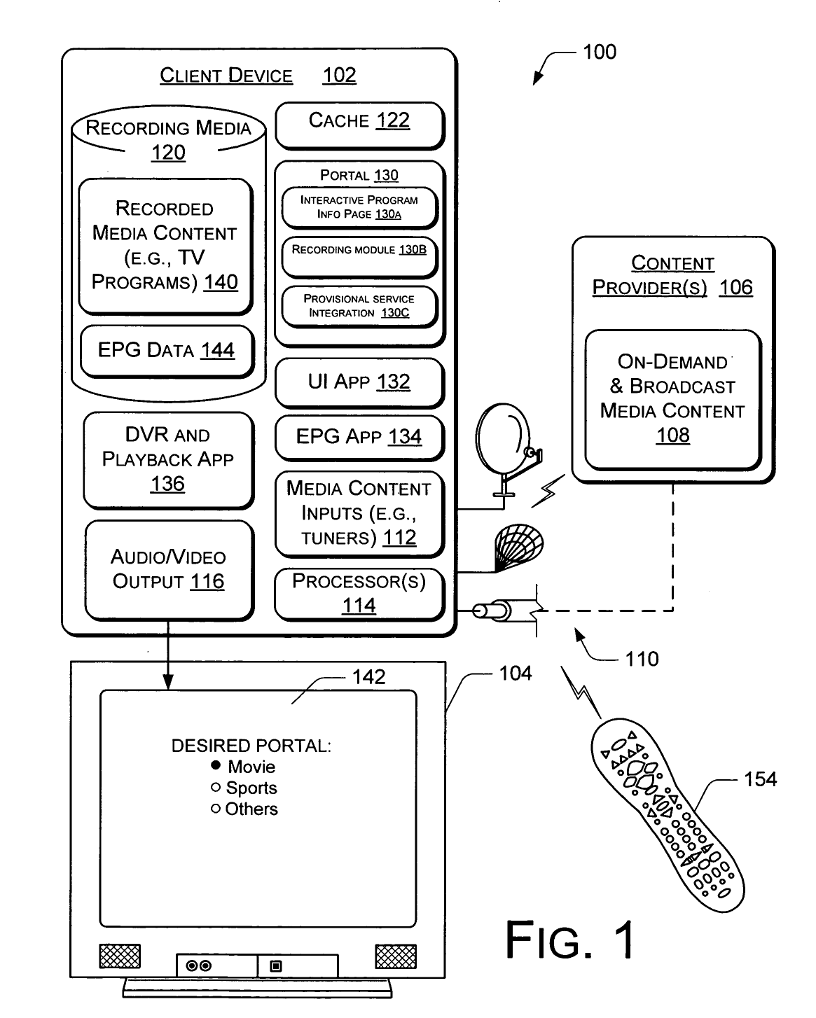

FIG. 1 illustrates an exemplary system 100 for finding, viewing and recording programs such as television programs, including movies and other shows. System 100 can also be used to acquire additional information associated, in some manner, with such programs or acquired through the program, from not only local resources that reside on the system, but remote resources as will become apparent below.

System 100 includes a client device 102, a display 104 (e.g., television, monitor, etc.), and one or more content providers 106. The content providers 106 control distribution of on-demand and/or broadcast media content 108, such as movies, TV programs, commercials, music, and similar audio, video, and/or image content and metadata associated therewith. Content providers 106 are representative of satellite operators, network television operators, cable operators, Web-based content providers, guide data providers that provide electronic program guide data, and the like.

The client device 102 receives, presents and stores the media content 108 distributed by the content providers 106. In particular, the client device 102 is configured to receive and record TV programs broadcast or otherwise transmitted by the content providers 106. Examples of TV programs include news, sitcoms, comedies, TV movies, infomercials, talk shows, sporting events, movies and so on. The client device 102 can be implemented in many ways, including as a TV-enabled computer, a computer-based media server, a set-top box, a satellite receiver, a TV recorder with a hard disk, a digital video recorder (DVR), a game console, an information appliance, and so forth.

The client device 102 receives the media content 108 via various transmission media 110, such as satellite transmission, radio frequency transmission, cable transmission, and/or via any number of other transmission media, such as a file transfer protocol over a network (e.g., Internet or Intranet) and/or data packet communication. The client device 102 includes one or more media content inputs 112, which may include tuners that can be tuned to various frequencies or channels to receive television signals and/or Internet Protocol (IP) inputs over which streams of media content are received via an IP-based network.

The client device 102 also includes one or more processors 114 which process various instructions to control operation of client device 102, to execute applications stored on the client device, and to communicate with other electronic and computing devices. The processors 114 may further include a content processor to receive, process, and decode media content and program data. The client device 102 is also equipped with an audio/video output 116 that provides audio and video data to the display 104, or to other devices that process and/or display, or otherwise render, the audio and video data. Video and audio signals can be communicated from the client device 102 to the display 104 via an RF (radio frequency) link, S-video link, composite video link, component video link, analog audio connection, or other similar communication links.

The client device 102 is equipped with different types of memory components or computer-readable media, including both volatile and non-volatile memory. In this example, the client device 102 has a recording media 120 and a cache 122. The recording media 120 may be implemented in many ways using various non-volatile storage media, such as hard disk drives, RAID systems, recordable and/or rewritable discs, and so forth. Cache 122 can be implemented, for example, as random access memory (RAM) for faster access during data processing in client device 102. Although not shown, the client device may further include one or more data memory components as well as a program memory to store applications.

One or more application programs can be stored in program memory and executed by the processor(s) 114. Representative applications shown in FIG. 1 include a portal application 130, an interactive program information page application 130A, a recording module application 130B, a provisional services integration application 130C, a user interface (UI) application 132, an electronic program guide (EPG) application 134, and a DVR and playback application 136. An operating system (not shown) may also be maintained in storage and executed on processor(s) 114.

The DVR and playback application 136 records media content received from the content providers 106 in the recording media 120. The recorded media content 140 includes TV programs that a viewer has recorded to watch at a later time. The DVR and playback application 136 also facilitates playback of the recorded media content 140 on the display 104.

The UI application 132 allows a user to browse and select content recorded on the client device 102. The UI application 132 supports interactive and graphical UI screens that identify the media content 140 stored in the recording media 120 and offer options for handling the media content 140 in some manner. For example, the UI screens might enable navigation to various recorded content (e.g., audio, still images, video, TV programs, etc.), list recently recorded content, or provide detailed information on specific content. One exemplary UI screen 142 is depicted on the display 104. This UI screen 142 allows a user to select a particular portal to use to find, watch and record programs of interest to them, as well as acquire other information and data, as will become apparent below. In the present example, portal selections are presented to a user and allow the user to select amongst portals that access different program types. The term “program type” can refer to programs that fall into a defined or definable category. For example, a defined category of a program type can include more generalized program types such as sports-type programs. A definable type of program is a program type can include more specialized program types such as those that can have a “handcrafted” type of definition to allow for flexible portals to be constructed to cover special kinds of programs. For example, a definable type of program can include programs that might be transitory in nature, or programs that are associated with transitory types of programs. Examples of this are given below.

In the illustrated example, two different program types are shown-sports and movies, whose selection will take the user to a sports portal and movie portal respectively. It is to be appreciated that other program types/portals can be presented to a user for selection.

As an example, consider the following. Additional portals can include, without limitation, portals such as financial portals that can, for example, provide a list of today's market winners, market losers, top earning companies and the like, with links to video clips and/or news articles; a Billboard Hot 100 portal that can, for example, have album covers, artist links, artist album histories with links to buy/download the songs and, in some implementations, links with music channels in some satellite channels to listen to the songs in real time; a kid's portal with access to children's programming; a transient portal such as an Olympics portal that just exists for a couple months in and around the time the Olympic games are broadcast to include retrospectives that air on ESPN Classic, broadcasts of the various Olympic Trials (swimming, track, etc), as well as the games themselves; other transient portals such as sports playoffs portals (i.e. a baseball portal, a football portal, a hockey portal and the like); various specialized entertainment portals such as an Academy Awards portal that coalesces information about movies that have won Academy Awards and makes it easy to watch these movies and acquire additional information about them.

Needless to say, many various types of portals can be designed and directed to various types of audiences and can empower individual audience members to find, in an extremely rich, robust and integrated manner, not only programs of interest, but ancillary information which is not typically included in the electronic program guide, but which is associated, in some manner, with their programs of interest.

The EPG application 134 generates a program guide for presentation on the display 104. The program guide includes a schedule indicating when particular content will be broadcast for viewing and on which channel the content will be broadcast. The EPG application 134 enables a viewer to navigate through the program guide and locate broadcast programs, recorded programs, video on-demand programs and movies, interactive game selections, and other media access information or content of interest to the viewer. EPG data 144 is downloaded from the content providers 106 and stored in recording media 120, where it is accessed by the EPG application 134 to populate the program guide.

Portal application 130 provides, in at least some embodiments, visually interactive navigation and links through which a user can easily and conveniently discover not only programs currently listed in the program guide, but information associated with such programs, as well as programs and information that do not necessarily appear in the guide or reside on the local client device.

To that end, interactive program page information application 130A permits a user to interactively select EPG elements to acquire more information about those elements that may or may not reside on the local client device; alternately or additionally, recording module application 130B permits a user to record programs that are not listed in the guide, but which may be broadcast in the future, as well as other information that may or may not reside on the local client device; and alternately or additionally, provisional services integration application 130C permits a user to acquire programs (e.g. to view, record, purchase, rent and the like), that are not presently in the program guide. Each of these aspects is discussed below under its own separate heading.

The viewer can navigate the screen 142 using an input device, such as remote control handset 154.

Program Portal

In the discussion that follows, program portal application 130 is described in the context of a movie portal. It is to be appreciated and understood that the portal application can provide access to other program types in addition to movies and sports. As such, the following description is not intended to limit application of the claimed subject matter.

Each week there are hundreds and sometimes thousands of movies on television. Yet, identifying which movies are of particular interest to a user continues to be a daunting task. To address this and other problems, portal application 130 provides a destination from which a user can easily identify movies of interest to them. Specifically, when client device 102 receives its EPG data, portal application 130 processes the data to identify, in this example, all movies. It then categorizes the movies into several categories and visually presents the indicia of the categories to a user via a user interface to allow the user to make an appropriate selection. More specifically, in one embodiment, the categories include, without limitation, an “On Now” category, an “On Next” category, a “Top Rated” category, and “Genres” category. Another category, although not specifically shown, can include a “New Releases” category that lists movies that have recently been released.

In the illustrated and described embodiment, when a user selects one of the indicia, they can view not only programs that fall within a particular category, but they can view or otherwise have access to various metadata associated with a particular program. One type of metadata comprises non-textual images associated with individual programs, such as images derived from the program, e.g. screen shots, movie cover art and the like. Other course, other metadata can be utilized without departing from the spirit and scope of the claimed subject matter.

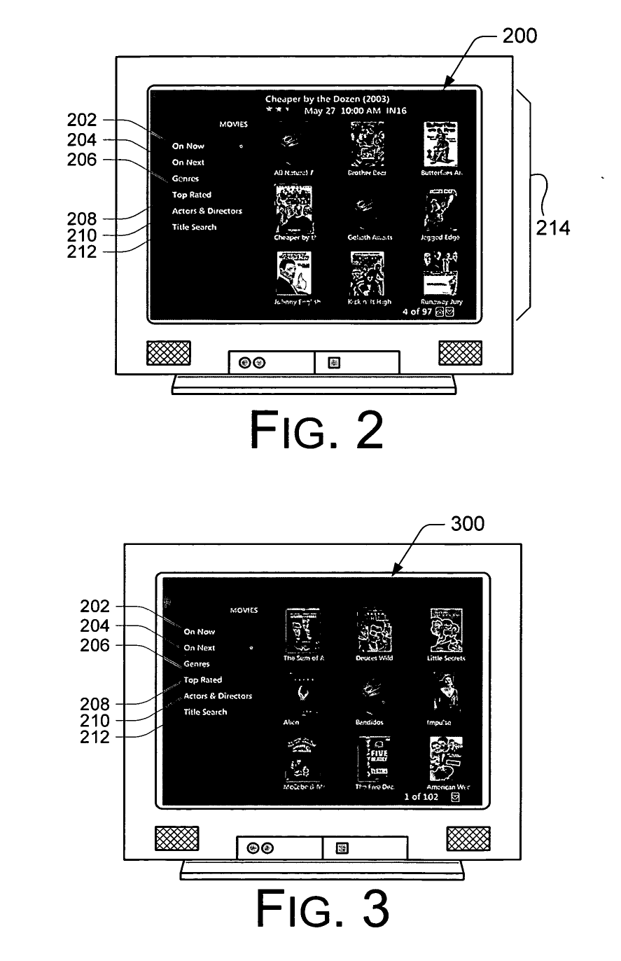

As an example, consider FIG. 2 which shows an exemplary user interface generally at 200. There, the different categories mentioned above, as well as others are shown, each of which is discussed below under its own separate heading. Specifically, FIG. 2 illustrates an On Now button 202, an On Next button 204, a Genres button 206, a Top Rated Button 208, an Actors and Directors button 210 and a Title Search button 212. It is to be appreciated and understood that in non-movies contexts, the Actors and Directors button 210 may have a different title. For example, in the sports context, the Actors and Directors button may be entitled “Player” or “Team”, thus allowing the user to discover additional information about a particular player or a particular team.

In addition, in at least some embodiments, the user experience is made more robust by presenting, along with movie titles, other metadata associated with the movie. In one embodiment, this other metadata includes visually-discernable artwork or images (also referred to as “cover art”) associated with the movies, such as those shown generally at 214. In this manner, the user is not simply presented with a flat list of movie titles. Rather, the user is presented with visually-discernable images, such as DVD covers and the like, associated with particular movies. Thus, the user's browsing experience is more enriching and robust than if they were simply presented with a flat list of movies.

In one embodiment, if a user has a persistent on-line connection to the Internet, access to the metadata which, in this instance comprises movie images, can be facilitated and made to be more robust, although a persistent connection is not necessary for access to various inventive features described herein. That is, as noted above in the description of FIG. 1, one of the content providers can be a Web-based content provider. In this case, when a user selects a particular UI button, an associated query is made of the content provider for any metadata, including visually-discernable images, associated with the user's selection. When the metadata is received, it is processed and, where appropriate, suitably displayed for the user. Once the metadata, such as an image, is acquired, it is or can be cached in the system's cache (e.g. cache 122 in FIG. 1) for future use if necessary. In some embodiments, the system can select which metadata to cache in order to save space in the system's memory. In the event the user does not have a persistent on-line connection to the Internet and the metadata or pertinent image is not cached in the user's cache, a generic movie image can be displayed.

On Now

The On Now button 202 provides a user with access to a list of movies (along with associated metadata such as images) that are presently being broadcast. In the illustrated and described embodiment, movies are sorted in reverse chronological order by default. For example, if it is currently 8:30 P.M. and there are three movies on now—one that started at 8 P.M., one that started at 7:30 P.M., and one that started at 7 P.M.,—the sort and presentation order would be, from left to right, the movies that respectively started at 8 P.M., 7:30 P.M. and 7 P.M..

In addition, in at least some embodiments, a secondary sort can be performed that sorts movies by name. For example, if two movies started at 7 P.M., e.g. Star Wars and Alien, Alien would appear first in the list. A contextual menu also allows users to sort by name. Sorting by name or date displays only the next showing of the movie. In the FIG. 2 example, several movies have been identified as being “on now”. In addition to listing the movies and showing their associated images, the movies have been secondarily sorted by name such that they appear alphabetically. Additionally, in the view shown in FIG. 2, nine movies and their associated images are displayed at a time. In a wide screen format, however, more than nine movies can be displayed at a time, e.g. twelve or more. It is to be appreciated that many different layouts are possible.

In this example, once a user selects or highlights a particular movie, metadata associated with the movie appears at the top of the screen. In this particular example, the user has selected the movie “Cheaper by the Dozen” and hence, its associated metadata is displayed at the top of the screen, including its title, star rating, airing date, and channel name. It should also be appreciated that a program rating, such as an MPAA rating of PG, PG-13, R and the like can be presented to the user as well. Additionally, these program ratings can provide a basis for sorting and filtering, as will be appreciated by the skilled artisan. Once a particular movie is selected, it can be recorded by the user by simply clicking a “Record” button, discussed below.

In addition to presenting movies and their associated metadata, e.g. images, in a sorted order for the user, the user can select an option that changes the view to a list or flat view of the movie titles. In the list view, movie titles are displayed in a scrolling list and a designation “Now” can be displayed to indicate which movies are presently being broadcast. Alternately or additionally, other relevant metadata can be displayed, such as start time, end time, duration and the like.

In one embodiment, clicking on a particular program or movie navigates the user to the Interactive Program Information page, discussed in more detail below under the heading “Interactive Program Information Page”.

In this embodiment, once a movie ends, it is removed from the list. In addition, movies are not displayed if they air on channels that either do not appear in the user's lineup or have been removed by the user. In this manner, the user is presented with a movie selection that is specific to their particular collection of channels.

On Next

The On Next button 204 enables a user to make a selection that displays movies that start during a next predefined period of time. Although any suitable predefined period of time can be used, in one embodiment the predefined period of time has been selected to be two hours. Hence, by selecting button 204, a user is presented with indicia of movies that start in the next two hours.

In this embodiment, movies are sorted in chronological order by default. As an example, consider FIG. 3 which shows an exemplary user interface 300 that is presented to a user upon selection of the On Next button 204. In addition, a secondary sort is conducted by name such that if two movies start at the same time, they are listed in alphabetical order. In the FIG. 3 example, the movie “The Sum of All Fears” is the next movie to start. Additionally, the movies “Deuces Wild” and “Little Secrets” start at the same time, hence they are presented in alphabetical order.

In this example, as in the example above, once a user selects or highlights a particular movie, metadata associated with the movie appears at the top of the screen. Once a particular movie is selected, it can be recorded by the user by simply clicking a “Record” button, discussed below.

In addition to presenting movies and their associated images in a sorted order for the user, the user can select an option that changes the view to a list or flat view of the movie titles. In the list view, movie titles are displayed in a scrolling list.

In one embodiment, clicking on a particular program or movie navigates the user to the Interactive Program Information page, discussed in more detail below under the heading “Interactive Program Information Page”. In addition, movies are not displayed if they air on channels that either do not appear in the user's lineup or have been removed by the user. In this manner, the user is presented with a movie selection that is specific to their particular collection of channels.

On Now/On Next Extensions

It is to be appreciated that the notion of displaying movie indicia, as described above, can be extended well beyond the “On Now” and “On Next” context. Specifically, other categories can be created and used to enhance the user's experience. For example, an “On Tonight” feature may allow a user to ascertain quickly which programs or movies are going to be broadcast on a particular evening. Likewise, an “On Friday Night” category can enable a user to ascertain programs that are to be broadcast on a particular Friday night.

Thus, these features allow a fixed window in time to be defined and for programs and associated indicia, such as images, to be displayed for the user to make their selections.

Genres

The Genres button 206 enables a user to make a selection that displays movies in accordance with a genre into which the movies are categorized. In the illustrated and described embodiment, the genres include, without limitation: Action and Adventure, Adults Only, Children, Comedy, Drama, Family, Fantasy, Horror, Musical, Mystery, Romance, Science Fiction, Suspense and Western.

In one embodiment, the genre selection pertains to movies that are on “now” and to movies that are on for the remainder of the EPG data, e.g. 14 or less days. In this example, movies are sorted in chronological order by default.

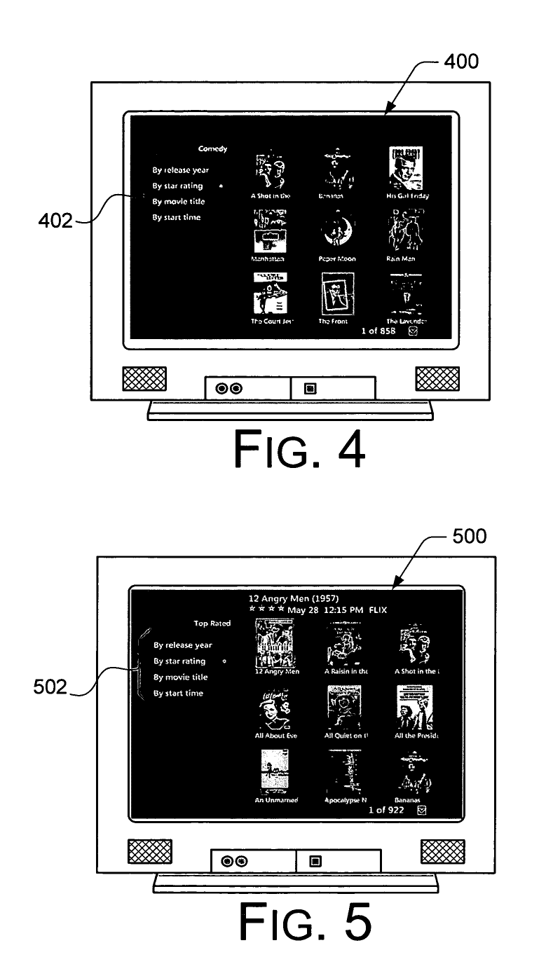

As an example, consider FIG. 4 which shows an exemplary user interface 400 that is presented to a user upon selection of genre button 206 (FIG. 3). In addition to being presented with movies that fall into a particular genre, various sorting operations can be performed on the movies, based on various parameters. To perform sorting, user interface 400 presents various buttons 402 which, in accordance with the user's selection, sorts the genre-based movies.

In the illustrated and described embodiment, the sorting parameters are presented to the user in the form of a “By release year” button, “By star rating” button, “By movie title” button, and “By start time” button.

In the present example, the user has selected the Comedy genre and additionally, has selected the “By star rating” button. Accordingly, displayed comedy movies are sorted to present the 4-star rated Comedy movies first.

In addition, in at least some embodiments, a secondary sort can be performed that sorts movies by name. Thus, the movies can be presented in alphabetical order. Additionally, in the view shown in FIG. 4, nine movies and their associated images are displayed at a time. In a wide screen format, however, more than nine movies can be displayed at a time, e.g. twelve or more.

In this example, once a user selects a particular movie, metadata associated with the movie appears at the top of the screen. In this particular example, the associated metadata includes the movie's title, star rating, airing date, and channel name. Once a particular movie is selected, it can be recorded by the user by simply clicking a “Record” button, discussed below.

In addition to presenting movies and their associated metadata, e.g. images, in a sorted order for the user, the user can select an option that changes the view to a list or flat view of the movie titles. In the list view, movie titles are displayed in a scrolling list and a designation “Now” is displayed to indicate which movies are presently being broadcast. In one embodiment, clicking on a particular program or movie navigates the user to the Interactive Program Information page, discussed in more detail below under the heading “Interactive Program Information Page”.

Top Rated

The top rated button 208 (FIG. 3) enables the user to view movie selections that are ranked in accordance with rating criteria. The ranked movie selections pertain to movies that are on “now” and to movies that are on for the remainder of the EPG data, e.g. 14 or less days. Although any suitable rating criteria can be used, in the illustrated and described embodiment, the rating criteria are provided by a vendor that provides movie ratings. In this example, movies are rated from between 1- to 4-stars, with a 1-star movie being at the low end of the spectrum and a 4-star movie being at the high end of the spectrum. Thus, using this feature, a user can see the best movies (or the worst movies and those in between) in accordance with the rating criteria.

In accordance with one embodiment, movies that are rated at least 3 stars or higher appear in the “Top Rated” category. In this example, movies are sorted in chronological order by default and, for movies with multiple airings, only the next airing is shown.

As an example, consider FIG. 5 which shows an exemplary user interface 500 that is presented to a user upon selection of top rated button 208 (FIG. 3). In addition to being presented with the top rated movies, various sorting operations can be performed on the top rated movies, based on various parameters. To perform sorting, user interface 500 presents various buttons 502 which, in accordance with the user's selection, sorts the top rated movies.

In the illustrated and described embodiment, the sorting parameters are presented to the user in the form of a “By release year” button, “By star rating” button, “By movie title” button, and “By start time” button.

For example, if the user wishes to see only the 4-star rated movies, then the user can select this parameter and only the 4-star movies will be presented. In addition, having performed the 4-star sorting, the user may now wish to see only movies released in 1982. In this case, by selecting the release year button and entering the year “1982”, the 4-star rated movies released in 1982 would now be displayed for the user.

In addition, in at least some embodiments, a secondary sort can be performed that sorts movies by name. Thus, the movies can be presented in alphabetical order. Additionally, in the view shown in FIG. 5, nine movies and their associated images are displayed at a time. In a wide screen format, however, more than nine movies can be displayed at a time, e.g. twelve or more.

In this example, once a user selects a particular movie, metadata associated with the movie appears at the top of the screen. In this particular example, the user has selected the movie “12 Angry Men” and hence, its associated metadata is displayed at the top of the screen, including its title, star rating, airing date, and channel name. Once a particular movie is selected, it can be recorded by the user by simply clicking a “Record” button, discussed below.

In addition to presenting movies and their associated metadata, e.g. images, in a sorted order for the user, the user can select an option that changes the view to a list or flat view of the movie titles. In the list view, movie titles are displayed in a scrolling list and a designation “Now” is displayed to indicate which movies are presently being broadcast.

In addition, in this and the other examples above, filtering and sorting options can be combined so that a user can, for example, select movies that are on “Now” that were released in a particular year. Additionally, the user can then sort I the resultant set by star rating so that, of the movies currently playing, their resultant list shows the top-rated movies in a particular year. In one embodiment, clicking on a particular program or movie navigates the user to the Interactive Program Information page, discussed in more detail below under the heading “Interactive Program Information Page”.

People Information Page—e.g., Actors and Directors

In one embodiment, additional information can be provided to the user through the use of a user interface button that enables them to access a list of people associated with a particular program. In the context of the movie portal, this button takes the form of the actors and directors button 210, which enables the user to conduct a search based on an actor's or director's name. Thus, a user can locate a favorite actor or director. This search need not be associated with a particular program in which the user is interested. Put another way, this search can be independent of any particular program that is the subject of the user's current browsing activities. In the illustrated and described embodiment, when a user selects the actors and directors button 210, they are presented with a user interface that presents not only an actor's or director's name, but additional metadata associated with that person, e.g. an image of the person that shows their face. The image can constitute, for example, a screen shot or movie cover image. Alternately, the image can comprise a screen actor's guild picture.

As an example, consider FIG. 6 which shows a user interface 600 that is presented to the user when the user clicks on the actors and directors button 210. Notice that the list of actors appears, by default, in alphabetical order. Notice also that each actor has an associated image that is presented for the user. This is advantageous in the event a user does not know a particular actor's name. Specifically, by browsing images, a user may likely encounter a picture of the actor and, by clicking on the actor's image, can ascertain more information about the actor, as will be described below.

Additionally, in this embodiment, a number of additional buttons, indicated generally at 602, are provided and enable a user to narrow down the actors and directors list. Specifically, in this example, the additional buttons include a “Top Actors” button, a “Top Actresses” button, a “Top Directors” button, an “Actor Search” button, and a “Director Search” button.

The “Top” buttons retrieve a list of associated top actors, actresses or directors for the user. Any suitable criteria can be used to rank actors, actresses or directors as “top”. For example, actors/actresses/directors who receive one or more academy award nominations and actually receive an award might be categorized as “top”. This list can be created in any suitable way. For example, in some embodiments, this list can be created using guide data that resides in the client device. Alternately or additionally, this list can be created using a fixed list in the client device. Alternately or additionally, this list can be created using an on-line connection with one or more servers. Alternately or additionally, the list can be created dynamically by the client.

The “Search” buttons enable a user to conduct a search for a particular name. Examples of how searches can be performed are given below under the heading “Search”.

In accordance with one embodiment, when a user clicks on a particular actor's image in interface 600, they can acquire additional information about the actor. For example, in the event that the user's client device has a persistent on-line connection and/or the information has been previously cached in the client, clicking on a particular image can acquire the actor's complete filmography and biography from a source remote from the client device, e.g. a content provider 106 (FIG. 1). In addition, in some embodiments, the filmography list can be sorted in accordance with movies that are available through the EPG currently, and then movies at least some of which are available from a provisional service, as will be described in more detail in the section entitled “Provisional Service Integration” below.

In the event the user's client device does not have a persistent on-line connection, then clicking on a particular actor's image will retrieve a list of movies (and possibly images if cached) that are available through the current EPG.

Search

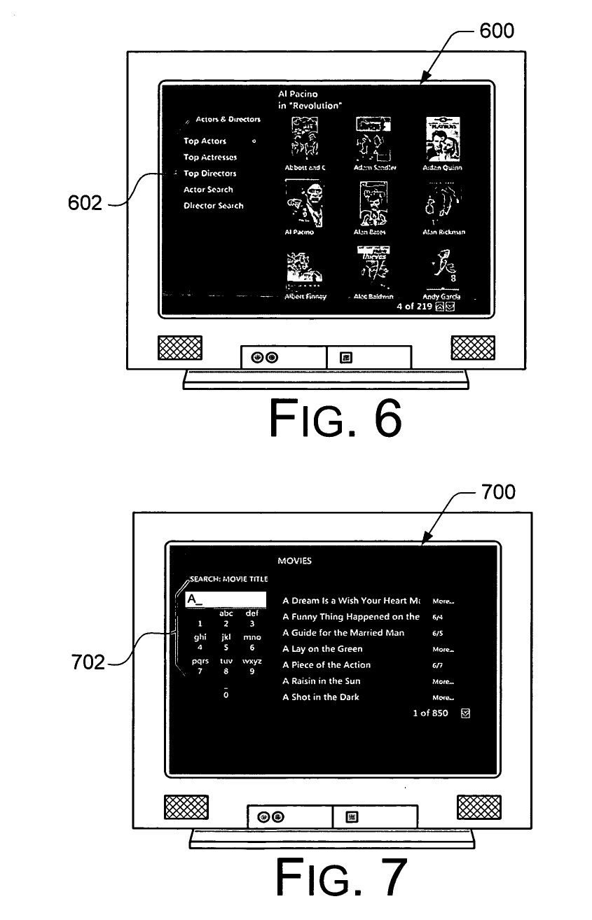

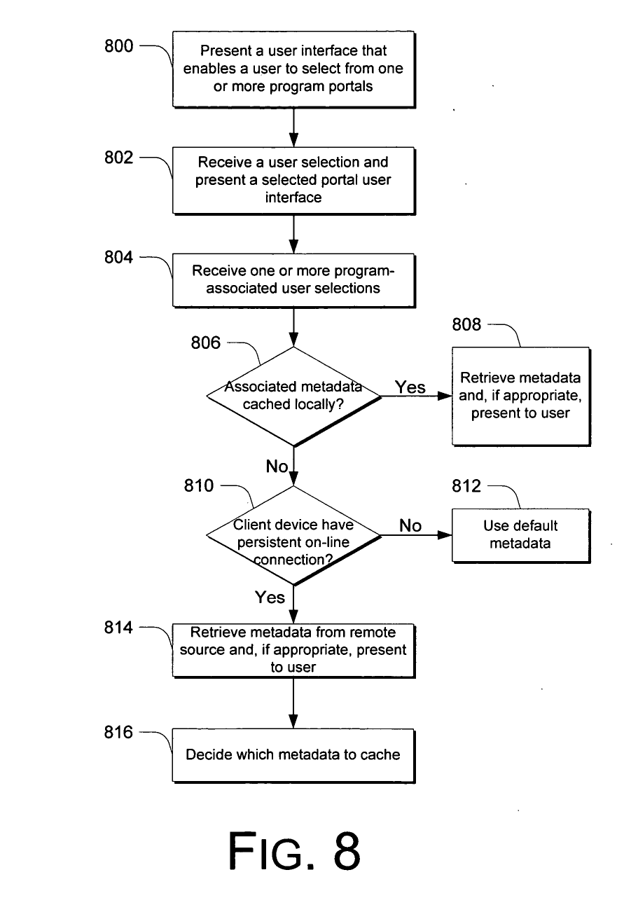

In the illustrated and described embodiment, a user is able to conduct a search based on movie title, actor name or director. As an example, consider Fig. 7 which shows a user interface 700 that permits a user to conduct a search. In this example, this user interface can be accessed by clicking on the search item 212 in FIG. 2. In this example, the user is searching by movie title and is assisted in their search by a collection of buttons indicated generally at 702.

In this example, the title search allows a user to find a specific movie by its title. As a user types in a movie title, the list to the right of the text entry area dynamically changes, thus showing movies currently in the guide. In this example, all results are in list view. In the illustrated and described embodiment, the results are sorted by name by default and the title and next airing date/time or “Now” is displayed if it is presently being shown. Clicking on a particular movie in the search results navigates the user to the Interactive Program Information page described in more detail below.

Conducting an actor/actress search allows users to find movies in the guide associated with a particular movie actor and actress. The behavior is the same as the movie title search. As a user types in an actor or actress name, the list to the right of the text entry area dynamically changes to show actor/actress names that currently appear in the guide. In the illustrated and described embodiment, the list is sorted alphabetically. Clicking an actor/actress name navigates the user to an actor page with a complete filmography/biography (in the event of a persistent on-line connection). A director search behaves in the same manner as an actor/actress search.

Exemplary Method

FIG. 8 is a flow diagram that describes steps in a method in accordance with one embodiment. The method can be implemented in connection with any suitable hardware, software, firmware or combination thereof. In at least one embodiment, the method is implemented by a client device, such as the client device 102 executing portal application 130 in FIG. 1.

Step 800 presents a user interface that enables a user to select from one or more portals. In the example of FIG. 1, the user can select from among a movie portal and a sports portal. It is to be appreciated and understood, however, that other portals can be provided without departing from the spirit and scope of the claimed subject matter. Once a user is presented with this interface, step 802 receives a user selection and presents a selected portal user interface to the user. In the example above, the user selects the movie portal and is presented, as indicated in FIG. 2, with a portal user interface 200.

From portal user interface 200, a user is able to make program-associated selections to find programs of interest that are accessible through that portal (e.g. locally through the local EPG data and, in the event of a persistent on-line connection, remotely through a remote content provider). Accordingly, step 804 receives one or more program-associated user selections. In the example of FIG. 2, these program-associated selections comprise selections associated with movies that are currently playing (i.e. the “On Now” selection), movies that are on in the future (i.e. the “On Next” selection), genre selections and top rated selections. In addition, the program-associated user selections can be made to identify movies that star or are directed respectively, by particular actors or directors. In addition, a program-associated selection can involve selecting a search option that allows the user to conduct a search to identify movies by title, actor or director.

The genre and search selections can be considered, for purposes of this discussion, as a sort of intermediate selection that enables a user to more narrowly construct or otherwise tailor a search in accordance with the user's own defined criteria.

Once the program-associated user selection is made, whether directly through selection of one or more of buttons 202, 204, 208, and 210 or in an intermediate way by a follow on selection after selecting one or more of buttons 206 and 212, step 806 ascertains whether any associated metadata, e.g. images, are cached locally on the client device. For example, in the FIG. 2 example, the user has selected the “On Now” button 202. Consequently, a number of images associated with movies that are currently playing are displayed for the user to facilitate their movie selection. In accordance with the described embodiment, the user's selection generates a database query that queries the client's local data for movies that are currently playing. In addition, this selection generates a query that ascertains whether any of the currently playing movies that are to be immediately displayed for the user have associated images that are locally cached. For is example, in the event the user previously had the occasion to view a particular movie's image on the user interface, that image would be cached for future use. Hence, in the event that the image is locally cached, step 808 retrieves the metadata and, if appropriate, presents the metadata, e.g. the image(s), to the user via the user interface.

If, on the other hand, the associated metadata is not locally cached, step 810 ascertains whether the client device has a persistent on-line connection. In the event there is no on-line connection, step 812 can use default metadata, such as a default image, for use in association with a particular user's selection. Alternately or additionally, the user can be queried to have the system create a persistent on-line connection. On the other hand, if the client device does have a persistent on-line connection, step 814 retrieves the metadata, e.g. the image(s), from a remote source and, if appropriate, presents the metadata to the user via the user interface. In this example, the user's selection generates a query that contains information that identifies a particular movie of interest. This information can comprise any suitable information such as title, release year, a unique identification, and/or station and channel name and time. This query is transmitted to the remote source over, for example, the Internet, whereupon the remote source returns the metadata or image(s) of interest, as well as any appropriate information, to the client device for display. In this example, the metadata or remotely-retrieved image is then cached, for example, in cache 122 (FIG. 1) for future use. Examples of additional information that can be returned with an image are given below.

Having retrieved the metadata, step 816 can decide which metadata to cache. For example, in some embodiments, this step can take into account the system's memory resources and can make intelligent decisions on which metadata to cache and which metadata not to cache, with an eye to efficiently using the memory resources. Alternately or additionally, the system can decide which metadata to cache based on user preferences. For example, a user might select a particular actor and add the actor's name to a “top actor” list such metadata associated with this actor is cached to enable the user to customize his or her own top actor page.

In accordance with one embodiment, image retrieval is conducted in a manner that attempts to predictably pre-fetch images that a user may likely navigate to from presently-displayed images.

For example, assume that the user has just selected the “On Now” button 202 (FIG. 2). Assume also that the user has a persistent on-line connection. In this case, step 806 above can check the cache not only for images that are currently required for display, but it can also check for images that occur in the page immediately after the page that is to be currently displayed. Thus, if the next-required images are not cached, then step 814 can retrieve those images as well. Accordingly, if a user pages down in the interface, they can immediately see the images that pertain to the next page. In this case, step 806 can check the cache for images that are required for the next page down and repeat the operation.

As another example, consider a situation in which a user has sorted movies alphabetically and selects the letter “N”. In this case, it is possible for a user to page up or page down from the currently-displayed page. In this case, step 806 can check the local cache for images associated with the page before and the page after the currently-displayed page. In the event an image from either or both of the pages is needed, step 814 can retrieve the associated images in anticipation of a user either paging up or down.

Interactive Program Information Page

There are many PVR products on the market and most of them include some sort of interactive television guide or electronic program guide in which a user can click on a current or future program and get information on that particular program. This information can include such things as the title of the program, a short description of the program and the scheduled show times. However, once a user receives this information, they are at somewhat of a dead end insofar as the information acquisition process is concerned. That is, current systems tend to provide a very small amount of information about the program and nothing more.

In accordance with the described embodiment, an interactive program information page application 130A (FIG. 1) executes to provide the user with an interactive experience in which the user can select elements within the electronic program guide and acquire additional information about those elements. In the illustrated and described embodiment, these elements, for a particular program, include without limitation actors in the program, directors of the program, program genre, star rating, and the like. In essence, any piece of suitable information in an interactive program information page can serve as a springboard into further information that may or may not necessarily be related to the particular program relative to which the user's selection is made. In addition, this information can be acquired from data that resides on the client device, e.g. guide data. Alternately or additionally, this information can be acquired from sources that are remote from the client device, such as remote servers and the like.

For example, in at least some embodiments, a user can select an actor in a particular program and, responsively, the interactive program information page application can acquire and display further information on that actor. Such information can include, without limitation, the actor's biography/filmography, scheduled television appearances in the current guide data, and the like. Accordingly, the interactive program information page can use locally stored EPG data to conduct an associated search on a particular user selection (e.g. to ascertain scheduled television appearances of an associated actor). Additionally, if the client device has a persistent on-line connection, associated searches can be conducted of remote content providers (e.g. to acquire a filmography or biography).

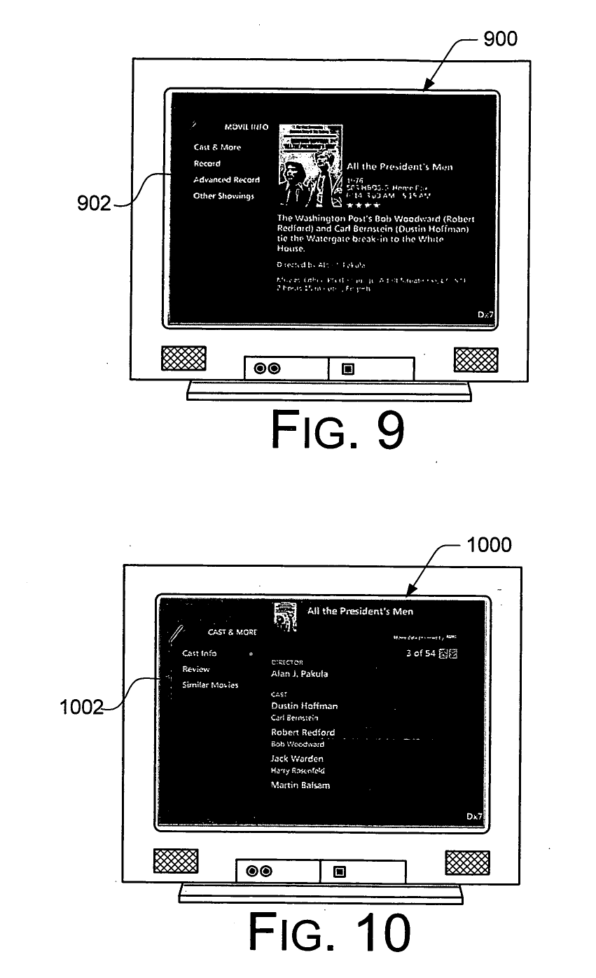

As an example, consider FIG. 9 which illustrates an exemplary user interface 900 that presents an interactive program information page in accordance with one embodiment. In this example, the user interface 900 includes a collection of buttons at least some of which allow a user to discover more information about a particular program. In the present example, the interactive program information page displays information associated with the movie “All the President's Men”. In this example, an image of the movie's cover art is presented along with other associated metadata such as release year, scheduled channel, show time and date, star rating, a short synopsis and other information. A “Record” button enables the user to one-touch record the movie on its next showing.

Notice also that a button entitled “Cast & More” is presented to the user and enables the user to navigate to a richer collection of information. When a user clicks on this button, additional information acquired from either or both of the local EPG data or a remote content provider is displayed for the user.

As an example, consider FIG. 10 which shows an exemplary user interface 1000 which is presented to a user upon selection of the “Cast & More” button of FIG. 9. Here, the additional information that is presented to the user includes a list of the cast in a particular movie, along with a list of the characters portrayed by each actor. In this particular embodiment, the complete cast listing as well as the associated characters portrayed by the individual cast members is acquired from a remote source. In addition, a number of buttons, generally indicated at 1002, are provided to enable a user to acquire even more information about the individual elements listed in this particular display. In this example, the additional buttons include a “Cast Info” button to ascertain additional information about the cast, a “Review” button to acquire one or more reviews of the particular movie, and a “Similar Movies” button. As noted above,'this additional information need not be related to the particular movie from which the element is selected.

As an example, consider that in the user's perusal of the metadata associated with “All the President's Men”, the user becomes interested in actor Robert Redford and wishes to acquire additional information on this actor. In this case, the user can simply click on the text “Robert Redford” appearing in this user interface and be navigated to the interactive page shown in FIG. 11.

FIG. 11 shows a user interface 1100 in the form of an interactive actor page that provides information associated with actor Robert Redford. In this example, a list of Redford's movies appears along with associated cover art of each movie (if available). In addition, a collection of buttons 1102 enables a user to acquire additional information about a particular selected actor. For example, a “Biography” button allows a user to select a particular actor's biography for display, a “Movies” button (which is currently selected) allows a user to view various movies in which the particular actor has appeared. Additionally, a “TV Shows” button allows the user have a presentation that describes the upcoming television programs on which the actor is scheduled to appear. In this example, a user is also given the ability to select multiple movies or programs for recording. For example, by clicking on the “Movies” button, the user is presented with a number of movies in which Robert Redford has appeared. The user can then one-click on the movies to indicate that they are to be recorded when broadcast. When clicked on in this manner, a small red dot will appear next to a movie to indicate that it has been selected for recording. In this example, a dot appears next to “Ordinary People” and “Spy Game” indicating that a user has selected these for recording in the future. Alternately or additionally, a user can select all of the movies for recording and can then be presented with a user interface that allows them to narrow down the movie choices for recording. For example, a user might select all of the Redford movies for recording and then define, through a particular interface, that only movies of the genre “Western” made between the years 1965 and 1985 be recorded. This way, the user is relieved of the task of browsing each of the individual movies to make their individual recording selections.

In this example, selection of a particular button can cause either or both of a local or remote query to acquire the associated information. For example, by selecting the “TV Shows” button, a query of the local EPG data is generated to ascertain any actor appearances in the current EPG. Selection of the “Movies” button can cause both a local query for current movies that appear in the EPO, and a remote query to ascertain movies that are not currently in the guide, but might be available for purchase, rent or download, as described in more detail in the section entitled “Provisional Service Integration” below.

In addition to enabling a user to make a selection of a particular actor or director for information retrieval as described above, at least one embodiment permits a user to define a relationship between selectable elements. Once a relationship is defined by the user, an associated query is made locally and, if possible, remotely to acquire additional information that pertains to the relationship defined by the user. As an example, assume that the user is interested in movies that star Robert Redford and which were directed by Alan Pakula. In this case, the user would select both Robert Redford and Alan Pakula, whereupon a query would be constructed that looks for movies that satisfy the search criteria. As noted above, this search can be conducted both locally and remotely.

Thus, it should be appreciated that, in at least some embodiments, the Interactive Program Information Page enables links to be created between local EPG data that resides in the client, and data that resides in one or more remote servers. Information which is returned from either one of the guide or the remote server can be used to query the other of the guide or the remote server. For example, a user can use the “On Now” feature to ascertain which movies are currently playing in the guide. With this information, the user can acquire, from a remote server, cast information, reviews, and information on similar movies. Likewise, the user can use similar movie names (acquired from a remote service) to query whether a particular movie is currently in the guide.

Thus, in at least some embodiments, a link can be created between downloaded EPG data and data available from a remote server.

Recording Module

PVR systems enable a user to watch and record television programs in which they are interested. Typical PVR systems provide an EPG which contains information about the coming few weeks of television—typically 1- to 4-weeks into the future. Over this time span, recording a favorite program is easy. One simply finds programs in the guide, and then selects those programs of interest and requests that they be recorded.

Where this ability breaks down, however, is when one deals with programs or a program's associated metadata that are not yet in the guide. For example, a user might have heard that in the fall television season a new series is coming called “Fleet Street”. Yet, since the program is not yet in the EPO, it cannot easily be selected for recording. In the past, PVR systems have allowed the user to enter the text string for the title of a particular program of interest for recording in the future. However, this approach is error prone for several reasons. First, the user typically has to spell the title correctly. If the user misspells the title, then it is likely that the program will be missed. Second, even if the user spells the title correctly, the title may change before the broadcast in which case the user would miss the program. In addition, multiple programs might have the same name, e.g. movie remakes.

In accordance with the described embodiment, a user interface is presented to the user in which the user can select a particular program, such as a movie, and have the system remember that selection and use information associated with that selection in a search to locate and, when broadcast, record the program or movie of interest.

In the illustrated and described embodiment, responsive to the user's selection of a particular program or movie, the system uses the title of the program or movie and additional information as markers to help precisely identify which program or programs should get recorded. As an example, consider the following. In a listing of all movies made in the United States, there will be at least two movies entitled “The Thing”. In this situation, through the user interface, the user can select, as by clicking on one of the desired movies, which of the movies to record. Responsive to the user's program or movie selection, the system will use not only the title of the movie, but the year the movie was released as well, to define a marker that can be used to identify when this particular version of the movie is broadcast. Using the additional information, the system can search on the EPG data and make the correct choice to record. For example, if the user selected the movie version produced in 1990, then simply searching “1990” as the year of production along with the movie title allows the system to record the correct version of the movie. Of course, different and/or additional information can be used as a marker to even more precisely hone in on the particular movie of interest. For example, a user may be interested in recording the movie “King Kong” and, accordingly, the system may define, responsive to the user's particular movie selection, a marker that includes the title and a set of actors appearing in the movie, e.g. Jeff Bridges and Charles Groden. Alternately or additionally, each movie or program can have a unique identifier, such as a globally unique identifier that could be used as the basis of the search.

In the above system, there are two ways that a user can get to a point where they wish to record movies not yet in the guide. First, a user can be exposed to such movies from the actor information page mentioned above. Second, a user can be exposed to such movies from the genre or similar movies page.

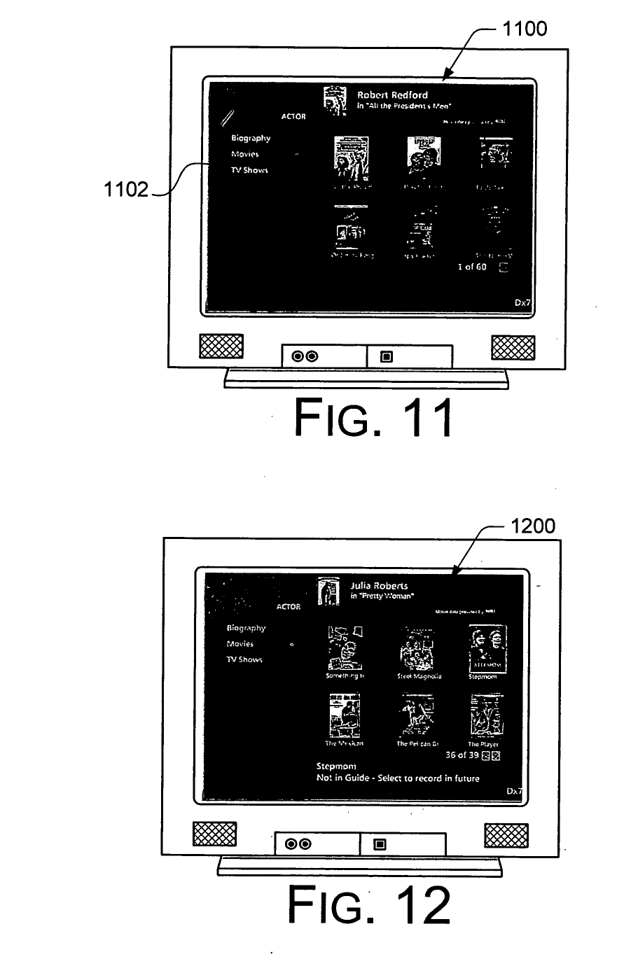

As an example, consider the following. FIG. 12 shows user interface 1200 in the form of an actor information page for Julia Roberts that lists the movies in which Julia Roberts has appeared. Since this listing constitutes a complete filmography, not all of the movies appearing in the actor information page are available in the current guide. For example, the movie “Stepmom” does not appear in the current guide. Assume that the user is interested in this movie and clicks on the movie to acquire additional information about the movie.

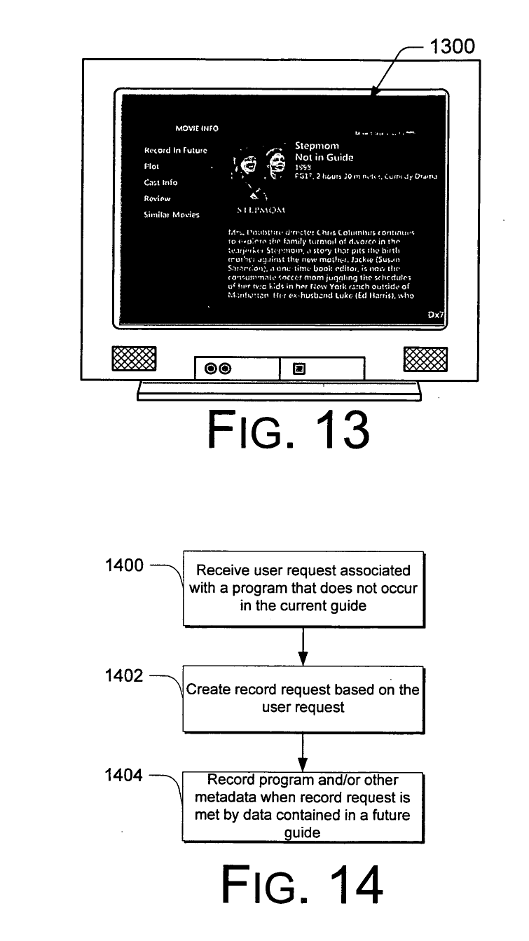

FIG. 13 shows a user interface 1300 in the form of an information page associated with the movie “Stepmom”. As with the previous user interface, the user is informed that the movie is not presently in the guide. In this example, however, the user is provided with a “Record In Future” button. By clicking on this button, the system sets up a query based on the movie's title and, in this example, release year (i.e. 1998) to ensure that in the future if the movie is broadcast, it is recorded for the user. That is, once the request for recording has been registered, the recording is basically equivalent to any recording for a show currently in the guide. In addition, in this embodiment, because the user can set up the “record in the future” functionality with a single click or selection, they do not have to type in any text pertaining to the movie and, accordingly, eliminate the risk of a user-induced typing error.

Alternately or additionally, the recording module 130B (FIG. 1) can be used to enable the user to record metadata for programs that do not yet appear in the guide. For example, the system can create a record request, as noted above, and in addition the system and/or the user can create a request to record metadata associated with programs that are the object of the record request. For example, in some situations, the user may be interested in reading reviews of the movies that are the subject of the record request. In this case, the user can designate that various metadata associated with such future programs are recorded when available.

Alternately or additionally, the user can cause metadata to be recorded and used by the system for future searches. For example, the user might have a list of top movies or top actors. In this case, the user can create a search request based on the metadata they provide and have the system use that search request for recording future programs, e.g. ones that have the user's favorite actor.

FIG. 14 is a flow diagram that describes steps in a method in accordance with one embodiment. The method can be implemented in connection with any suitable hardware, software, firmware or combination thereof In at least one embodiment, the method is implemented by a client device, such as client device 102 (FIG. 1) executing a recording module application 130B.

Step 1400 receives a user request associated with a program that does not occur in the current guide. In one embodiment, this user request can be a request to record a program that does not occur in the current guide. An example of how this act can be performed is given above. In another embodiment, this user request can be a request to record metadata associated with a program that does not occur in the current guide.

Step 1402 creates a record request based on the user request. This step can be implemented by building a request based on, for example, the program's title and additional information. In the illustrated and described embodiment, this step is performed automatically by the client system. For example, when the user clicks on a particular movie title, the system can automatically create the record requests using information, such as that described above, to formulate the request. Any suitable additional information can be used to construct the record request. In the example given above, the additional information comprises the release year of the movie of interest. Having constructed the record request, step 1404 records the program and/or metadata when the record request is met by data contained in a future guide. In this case, the executing application searches on the future guide data as it is received looking for a program that contains the same title and, in this example, release year. When it finds such a program, the application causes the program to be recorded when it is broadcast. Additionally, the application can also, at this time, execute its query to retrieve and record metadata associated with the program, pursuant to the user's previous request. Alternately or additionally, the system can record metadata associated with the user's request at a time other than when the program is broadcast. For example, if the metadata pertains to a particular movie's review, then the system might retrieve this information from a remote content source for the user to read prior to recording the movie.

Provisional Service Integration

Assume now that the user wishes to view or record a movie or program in the present. For example, the user may not wish to wait until a particular free- available movie that is not in the guide is broadcast in order for it to be recorded. Specifically, assume that a user has accessed a movie that is not in the guide either through the actor information page (as in the above example) or through a similar movies page.

In a situation like this, the client device, through the provisional service integration application 130C (FIG. 1) can check with external on-demand provisional service sources or partners to ascertain whether a particular movie is available for download, rent, purchase or other acquisition. If the movie is available from one of these provisional services, the user can be given an option to download or otherwise purchase or acquire a particular movie. In the illustrated and described embodiment, a provisional service source or provider will typically be an entity that is different from the entity from which the guide data or television service is provided.

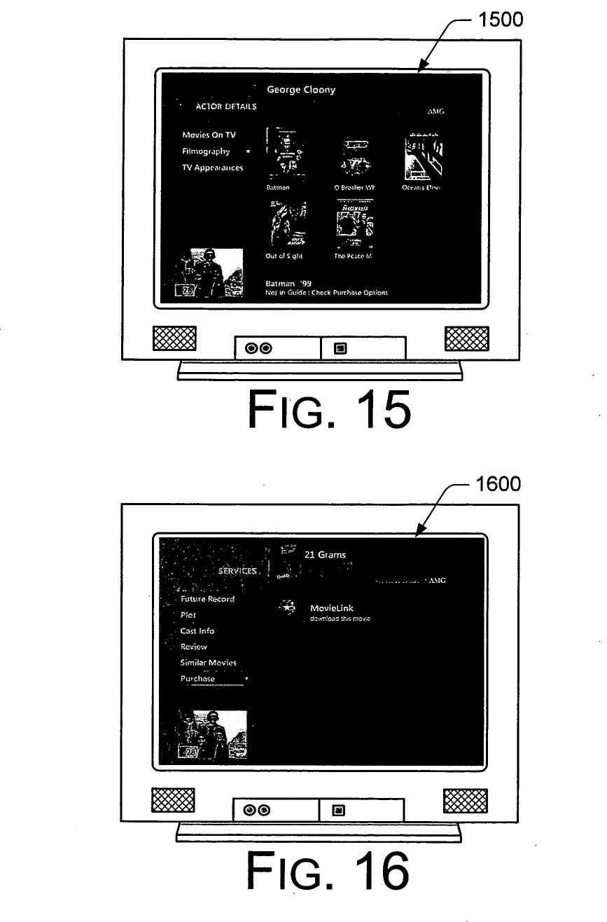

As an example, consider FIG. 15 which shows a user interface 1500 in the form of an actor's information that is presented to a user. In this particular example, the user has selected George Clooney as the actor of interest. In this case, one of the displayed movies—“Batman” does not appear in the current guide. That is, in this example, when the user selects the “Batman” movie, a notice at the bottom of the user interface indicates that the movie is not in the current guide and indicates that the user can check purchase options. If the user clicks on the “Check Purchase Options” link, the user is navigated to a page that contains indicia from one or more provisional services that can allow the user to purchase the movie. For example, FIG. 16 shows a user interface 1600 from which a user can select to purchase a movie that is not in the guide. That is, a “Purchase” button is displayed for the user from which they can select to purchase the particular movie of interest from one or more provisional service providers. Alternately or additionally, the user can be presented with options that allow the user to rent, download, subscribe to or otherwise receive a program of interest.

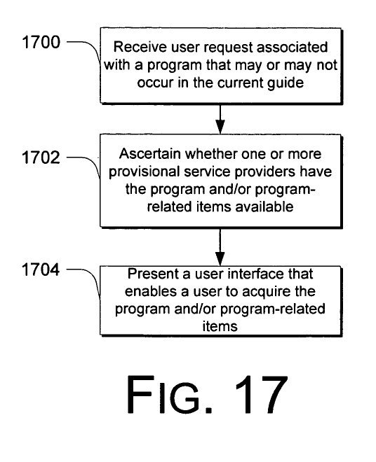

FIG. 17 is a flow diagram that describes steps in a method in accordance with one embodiment. The method can be implemented in connection with any suitable hardware, software, firmware or combination thereof. In at least one embodiment, the method is implemented by a client device, such as the client device executing a provisional service integration application, such as provisional service integration application 130C in FIG. 1.

Step 1700 receives user request associated with a program may or may not occur in the current guide. In one embodiment, this user request can be a request to record a program that does not occur in the current guide. Examples of how this act can be performed are given above. In other embodiments, this request can be a request for access to program-related items. These program-related items can comprise any suitable items that can be related to a particular program. For example, program-related items can include such things as books, movie posters, sound tracks and/or other merchandise associated with, or in some way connected with a program.

Step 1702 ascertains whether one or more provisional service providers have the program and/or program-related items available, for example, to purchase, rent, download or otherwise acquire. This step can be performed, for example, by generating a query to the one or more provisional service providers when a user navigates to a page that exposes movies that are not in the guide. For example, a user can navigate to such a page from the actor's information page.

Step 1704 presents a user interface that enables a user to acquire the program and/or program-related items. An example of such an interface is provided above in FIG. 16.

Conclusion

The above-described embodiments enable a user to find, watch and/or record programs of interest in a manner that greatly enhances the user's experience over past systems.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method comprising:
presenting, via a client device, a user interface that allows a user to make a selection to view a program that is not included in a current electronic program guide associated with the client device; and
using a unique marker associated with the program to search for the program in a future electronic program guide.

2. The method of claim 1 further comprising, prior to using said unique marker, building said unique marker using multiple pieces of information associated with the program.

3. The method of claim 1 further comprising, if the program is found in a future electronic program guide, recording the program when the program is broadcast.

4. The method of claim 1, wherein the unique marker comprises at least the title of the program.

5. The method of claim 1, wherein the unique marker does not comprise the title of the program.

6. The method of claim 1, wherein the act of presenting is performed by presenting, in the user interface, program titles and images associated with individual programs.

7. The method of claim 1, wherein the act of presenting is performed by presenting, in the user interface, program titles and images associated with individual programs, and wherein at least one of the program titles and associated image pertains to a program that is not included in the electronic program guide.

8. The method of claim 1, wherein said program comprises a movie.

9. The method of claim 1, wherein said program does not comprise a movie.

10. The method of claim 1, wherein said unique marker does not require the user to enter a text string.

11. One or more computer-readable media having computer-readable instructions which, when executed by one or more processors, cause the one or more processors to implement the method of claim 1.

12. A device embodying the one or more computer-readable media of claim 11.

13. A method comprising:
receiving a user request associated with a program that does not occur in a current electronic program guide;
creating a record request based on the user's request, wherein the record request does not rely solely, if at all, on the program's title; and
making a recording associated with the record request.

14. The method of claim 13, wherein said request comprises a request to record the program when it occurs in a future electronic program guide.

15. The method of claim 13, wherein said request comprises a request to record metadata associated with the program.

16. The method of claim 13, wherein said request comprises a request to record the program, as well as metadata associated with the program, when it occurs in a future electronic program guide.

17. The method of claim 13, wherein the program comprises a movie.

18. The method of claim 13, wherein the program does not comprise a movie.

19. The method of claim 13, wherein said act of making is performed at a time when said program is not being broadcast.

20. The method of claim 13, wherein said record request comprises a unique marker associated with the program.

21. One or more computer-readable media having computer readable instructions thereon which, when executed by one or more processors, cause the processors to implement the method of claim 13.

22. A device embodying the one or more computer-readable media of claim 21.

23. A method comprising:
receiving a user request to record a movie that does not occur in a current electronic program guide;
creating a record request based on the movie's title and at least one piece of addition information; and
recording the movie if it appears in a future electronic program guide.

24. The method of claim 23, wherein one piece of additional information comprises the movie's release year.

25. The method of claim 23, wherein the act of receiving is performed by presenting a user interface that includes multiple movie titles and images associated with individual movies.

26. The method of claim 23, wherein the act of receiving is performed by presenting a user interface that includes multiple movie titles and images associated with individual movies, and wherein at least some of said images comprise a movie's cover art.

27. The method of claim 23, wherein the user request is generated without requiring the user to enter a text string.

28. The method of claim 23, wherein the user request is generated by the user clicking on a single button in an associated user interface.

29. One or more computer-readable media having computer-readable instructions which, when executed by one or more processors, cause the one or more processors to implement the method of claim 23.

30. A device embodying the one or more computer-readable media of claim 29.

31. A system comprising:
one or more computer-readable media;
one or more processors;
computer-readable instructions on the one or more computer-readable media which, when executed by the one or more processors, cause the one or more processors to:
present a user interface that allows a user to make a selection pertaining to a program that is not included in an electronic program guide associated with the system;
build a record request associated with the selection, wherein the record request comprises a unique marker associated with the program, and wherein the record request is built responsive to the user clicking an associated button in the user interface and without requiring the user to enter a text string;
use the unique marker to search for the program in a future electronic program guide; and
if the program is found, record the program.

32. The system of claim 31, wherein the user interface displays at least program titles and images associated with individual programs.

33. The system of claim 31, wherein the program comprises a movie.

34. The system of claim 31, wherein the program does not comprise a movie.

35. The system of claim 31, wherein the unique marker comprises a globally unique identifier associated with the program.

36. The system of claim 31, wherein the unique marker comprises at least a program's title.

37. The system of claim 31, wherein the unique marker comprises the program's title and at least one additional piece of information associated with the program.
